(19) United States
(12) Patent Application Publication
(10) Pub. No.: US 2010/0043944 A1
(43) Pub. Date: Feb. 25, 2010

(54) Method for the material bonding of two metallic components

(76) Inventors: Jens Dahl Jensen, Berlin (DE); Ursus Krüger, Berlin (DE); Gabriele Winkler, Berlin (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/442,648

(22) PCT Filed: Sep. 25, 2007
(86) PCT No.: PCT/EP07/60151

§ 371 Date: Nov. 11, 2009

(30) Foreign Application Priority Data
Sep. 26, 2006 (DE) 10 2006 047 070.2

(51) Int. Cl. B23K 31/00; B23K 20/00

(52) U.S. Cl. 156/89.27; 156/89.28

(57) ABSTRACT

In a method for the material bonding of two metallic components (11a and 11b), a joining adjuvant (19) is applied to corresponding joining surfaces (12a, 12b), wherein the adjuvant has precursors for a ceramic. After joining the components, a heat treatment step is conducted, transforming the precursors of the ceramic into an intermediate layer, which firmly adheres to both of the joining areas (12a, 12b), thus creating a comparatively strong composite bond, particularly also between different types of metals. Other additives in the form of particles may advantageously be introduced into the joining adjuvant (19), allowing for an adaptation to the requirement profile.

### CROSS-REFERENCE TO RELATED APPLICATIONS

This application is a United States national phase filing under U.S.C. §371 of International Application No. PCT/EP2007/060151, filed Sep. 25, 2007 which claims priority to German Patent Application No. 10 2006 047 070.2, filed Sep. 26, 2006. The complete disclosure of the above-identified application is hereby fully incorporated herein by reference.

### TECHNICAL FIELD

The invention relates to a method for the material bonding of two metallic components using a joining adjuvant, which is applied to the joining surface of at least one of the components before the components are joined.

### BACKGROUND

A joining method of the type specified at the beginning is known for example from the abstract of JP 08282399 A. According to this method, an adhesive connection is established between two metallic sheet metal parts, these parts having an overlapping region to form joining surfaces. The adhesive is applied to this overlapping region before the two sheet metal parts are joined.

When designing adhesive connections, it must be remembered that they do not achieve the same strength as the metallic parts being joined, and therefore a load-bearing capacity that is adequate for the structural application is obtained by providing a sufficiently large overlapping region. As an alternative material bonding method, a welded or soldered connection could be formed for example between the metallic components. In this case, however, it must be noted that not all metals or metal pairings can be welded or soldered to one another.

### SUMMARY

According to various embodiments, a material bonding method for two metallic components can be provided which can be used for a comparatively large number of metal pairings with a comparatively high strength of the bonded connection.

According to an embodiment, a method for the material bonding of two metallic components may comprise to steps of: using a joining adjuvant, which is applied to the joining surface of at least one of the components before the components are joined, using precursors for a ceramic as the joining adjuvant and, after joining, subjecting the components to a heat treatment until the precursors have been chemically transformed into a metal compound forming the ceramic, thereby forming an intermediate layer connecting the components.

According to a further embodiment, the ceramic to be formed may comprise at least one of an oxide, a nitride, and an oxinitride. According to a further embodiment, at least one metal in the metal compound to be formed of the ceramic may be also contained in at least one of the components. According to a further embodiment, a metal carboxylate or a mixture of different metal carboxylates can be used as precursors for the ceramic. According to a further embodiment, the precursors for the ceramic can be dissolved in a solvent which contains a carboxylic acid, in particular 2-ethylhexanoic acid, acetic acid, propionic acid, hexanoic acid or levulinic acid, or mixtures of carboxylic acids, it also being possible for the acids that are used to have alkyl, alkenyl or alkynyl groups on the carbon chain. According to a further embodiment, a hydrazine compound, in particular hydrazine, monomethyl hydrazine or dimethyl hydrazine, or a mixture of different hydrazine compounds can be used as precursors for the ceramic. According to a further embodiment, the precursors for the ceramic may be dissolved in a solvent which contains water and/or at least one alcohol, in particular ethanol. According to a further embodiment, before joining the components, a time may be allowed, until a prescribed part of the solvent has evaporated. According to a further embodiment, the evaporation of the solvent can be assisted by heating the components coated with the joining adjuvant. According to a further embodiment, at least one additive, in particular a metal, such as Y, Re, Th, Nb, Ta, V, Tc, Al, Cu, Cr, Fe, Co, Pt, Pd, Ag, Au, Ti, Ni, a ceramic substance, such as aluminum oxide, magnesium oxide, titanium oxide, hexagonal or cubic boron nitride or silicon dioxide, or a dye, can be added in the form of particles to the joining adjuvant. According to a further embodiment, nanoparticles can be added as particles. According to a further embodiment, the components can be pressed together at the joining surfaces during the transformation of the precursors into the ceramic. According to a further embodiment, the joining adjuvant or joining adjuvants of respectively different composition may be applied to the joining surfaces of both components.

### BRIEF DESCRIPTION OF THE DRAWINGS

Further details of the invention are described below with reference to the drawing. The same or corresponding elements of the drawing are provided with the same designations in each case in the individual figures and are only explained more than once to the extent that there are differences between the individual figures. In the drawing:

FIGS. 1 to 4 show selected steps of an exemplary embodiment of the method and

FIG. 5 shows a section through a composite bond according to FIG. 4 as detail V.

### DETAILED DESCRIPTION

According to various embodiments, in a method as described at the beginning, precursors for a ceramic are used as the joining adjuvant and, after joining, the components are subjected to a heat treatment until the precursors have been chemically transformed into a metal compound forming the ceramic, thereby forming an intermediate layer connecting the components. The use of a ceramic joining adjuvant has the advantage that on the one hand ceramic materials have a strength that is comparable to or even greater than metallic materials, so that a bonded connection in the region of the joining adjuvant does not represent a weak point in the composite bond. Furthermore, an outstanding bond can be advantageously produced between most ceramic materials and metallic materials at an interface formed between them, so that failure of a material connection between two metallic components and a ceramic joining adjuvant is unlikely, even at the interfaces formed by the material connection. Consequently, on the one hand the high strength of the ceramic joining adjuvant and on the other hand the strong connection of the ceramic joining adjuvant to the metallic interfaces of the adjacent components advantageously lead to a comparatively high load-bearing capacity of the material bonded connection produced, which can even achieve the strength of welded connections.

In order to achieve the advantages discussed of the ceramic bonded connection, i.e. high strength of the transformed joining adjuvant or good bonding thereof to the metallic interfaces of the components, according to various embodiments the ceramic must be produced from precursors which, prior to chemical transformation into the actual ceramic, must be applied to at least one joining surface of the two components. Application of the joining adjuvant to both corresponding joining surfaces of the components to be joined is particularly advantageous. In this case, it is advantageously possible for a different composition to be respectively chosen for the joining adjuvants to be applied to the corresponding joining surfaces, allowing for example a multilayered structure of the bonded connection to be foamed. The chemical transformation of the precursors for the ceramic into the ceramic intermediate layer between the components to be connected also advantageously produces a particularly dense ceramic, which has a greater strength in comparison with sintered ceramics. Furthermore, the bonding of the ceramic intermediate layer to be created on the basis of the joining adjuvant can be improved by the joining adjuvant being applied to the joining surfaces of the components at the stage of ceramic precursors.

The method of applying ceramic precursors to metallic components for the purpose of forming ceramic layers on these components is known per se, and is described for example in US 2002/0086111 A1, WO 2004/013378 A1, US 2002/0041928 A1, WO 03/021004 A1 and WO 2004/104261 A1. However, the methods described in these documents are concerned only with the production of ceramic coatings on components, with ceramic precursors of the ceramics to be created that are transformed after application into the ceramic to be formed by a heat treatment being used for creating layers. That the precursors known per se for ceramics can also be used as a joining adjuvant for a material connection of metallic components is not mentioned however in the cited documents. This use presupposes the surprising realization that may be essential for various embodiments that the layers produced from the precursors not only have a high strength but, when used as an intermediate layer between the joining surfaces of two metallic components to be joined, also achieve such good bonding to the joining surfaces that the strength of the intermediate layer can also be used on the basis of the transferability of loads exerted on the components to be connected into the intermediate layer.

The precursors for the ceramic comprise the substances from which the ceramic material of the intermediate layer to be produced is composed and also have constituents which lead in the course of the chemical transformation occurring during the heat treatment of the joining adjuvant to a crosslinking of the ceramic material. Examples of ceramic precursors can be taken from the cited prior-art documents and must be selected in accordance with the metallic components to be connected.

According to an embodiment, it is provided that the ceramic to be formed comprises an oxide and/or a nitride and/or an oxinitride. The formation of oxides, nitrides or oxinitrides advantageously allows particularly load-bearing intermediate layers to be created. The precursors of such ceramics must provide the elements N and O for the forming of the oxidic, nitridic or oxinitridic ceramic.

Another embodiment provides that at least one metal in the metal compound to be formed is contained in at least one of the components, the metal compound forming the ceramic of the intermediate layer. The fact that precursors which contain the metal which also occurs in at least one of the components to be connected are used means that a similarity of the respective layer composition is achieved between the component and the intermediate layer. This advantageously allows undesired diffusion processes between the layer and the metallic component to be reduced. Furthermore, it is possible, for example, for there to remain in the intermediate layer metallic components which do not allow the transition between the intermediate layer and the component to take an abrupt form but create a transitional zone. This advantageously improves the bonding between the intermediate layer and the adjacent component.

According to a further embodiment, a metal carboxylate or a mixture of different metal carboxylates is used as precursors for the ceramic. Metal carboxylates are advantageously suitable for the forming of oxidic ceramics as an intermediate layer. It is advantageous to dissolve the precursors for the ceramic in a solvent, in order to facilitate the application of the precursors to the joining surfaces and improve the bonding of the layers to be formed. Possible solvents that come into consideration for carboxylates are, for example, 2-ethylhexanoic acid, acetic acid, propionic acid, hexanoic acid or levulinic acid or mixtures of the mentioned or other carboxylic acids. Furthermore, the carboxylic acids may also have alkyl, alkenyl or alkynyl groups, which are bonded to the carbon chain of the acid as substituents of a hydrogen atom. The application of the solution obtained in this way may take place for example by means of spraying, brushing, rolling, doctor blading or else immersion.

Another embodiment provides that a hydrazine compound, in particular hydrazine, monomethyl hydrazine or dimethyl hydrazine, or a mixture of different hydrazine compounds, as mentioned or others, are used as precursors for the ceramic. Further hydrazine compounds for producing precursors for the ceramic can be taken for example from the already mentioned US 2002/0086111 A1. With hydrazine compounds, nitridic ceramics, comprising metal nitrides, can be preferably created. Water and/or alcohols, such as for example ethanol, come into consideration as solvents for hydrazine compounds.

It goes without saying that precursors for nitridic ceramics, such as for example hydrazine, may also be mixed with precursors for oxidic ceramics, such as for example metal carboxylates. In this case, the solvent must also be correspondingly modified by a suitable mixture of the substances mentioned, so that a solution both of the hydrazines and of the metal carboxylates is possible. The chemical transformation of the precursors to a ceramic can be used to produce both mixtures from oxides and nitrides and also oxinitrides.

Another embodiment provides that, before joining the components, a time is allowed after applying the precursors for the ceramic, until a prescribed part of the solvent has evaporated. In this case, it may also be prescribed that the solvent must have evaporated completely, or at least almost completely. This makes allowance for the fact that, by joining the components, the surface that is available for the evaporation of the solvents is almost completely covered by the joining surfaces of the components, so that evaporation of the solvent after joining can scarcely take place. If a chemical transformation of the joining adjuvant is therefore intended to take place with a certain concentration of solvents in the joining adjuvant that does not correspond to the concentration when the joining adjuvant is applied to the joining surfaces, the adjustment of the concentration must take place by suitable evaporation of the solvent before the components are joined. It is particularly advantageous if the evaporation of the solvent is assisted by heating the components coated with the joining adjuvant. This allows the time that is required for the evaporation of a defined part of the solvent to be shortened. Furthermore, heating the components to a prescribed temperature creates a parameter for the evaporating operation that advantageously allows the process to be controlled.

Furthermore, it is advantageously possible to add at least one additive, in particular a metal, a ceramic substance, such as aluminum oxide, magnesium oxide, titanium oxide, hexagonal or cubic boron nitride or silicon dioxide, or else a dye, to the joining adjuvant. The joining adjuvant is in the form of particles. This allows the properties of the joining adjuvant or the properties of the layer to be created to be specifically influenced during processing. Metals such as Y, Re, Th, Nb, Ta, V or Tc act for example as stabilizers of the composition of the intermediate layer to be formed. Alternatively, Al, Cu, Cr, Fe, Co, Pt, Pd, Ag, Au, Ti or Ni may be added as metals. This allows, for example, the position of the layer material of the intermediate layer in the galvanic series of elements to be shifted, so that adaptation of the electrochemical behavior of the intermediate layer to the materials of the components to be joined can take place.

It is advantageous if the particles are added as nanoparticles. Nanoparticles are to be understood as meaning particles of an average diameter less than 100 nm. The use of nanoparticles is therefore particularly advantageous, since the particles introduced influence the microstructure of the formed ceramic of the intermediate layer less than, for example, microparticles. Furthermore, nanoparticles have a relatively large specific surface area, so that effects that develop on the basis of the surface area of the substance added can be achieved with comparatively low particle concentrations.

In order to improve the quality of the intermediate layer to be formed, according to a further embodiment, the components are pressed together at the joining surfaces while the precursors of the ceramic are being transformed in the course of the heat treatment. The higher pressure leads in particular to the avoidance of defects at the interfaces between the joining surfaces and the joining adjuvant, whereby the load-bearing capacity of the bonded connection is improved.

Furthermore, it may be advantageously provided that the joining adjuvant is applied to the joining surfaces of both components. This can advantageously achieve the effect that the bonding of the joining adjuvant respectively applied to the joining surfaces with the aid of the solvents in the joining adjuvant is optimized. In the joining operation and the subsequent heat treatment for creating the ceramic intermediate layer, the two interfaces of the joining adjuvant respectively applied to the joining surfaces are then brought one onto the other, an intimate connection being produced by the chemical transformation of the ceramic precursors between the two layers of joining adjuvant. Furthermore, particularly advantageously, a joining adjuvant of a different composition can be applied to each joining surface. The composition can be modified in particular with regard to the additives, whereby an optimum adaptation to the material of the respectively neighboring component can take place, for example, for each joining adjuvant. This allows the bonding of the intermediate layer to the respectively adjacent components to be advantageously further optimized.

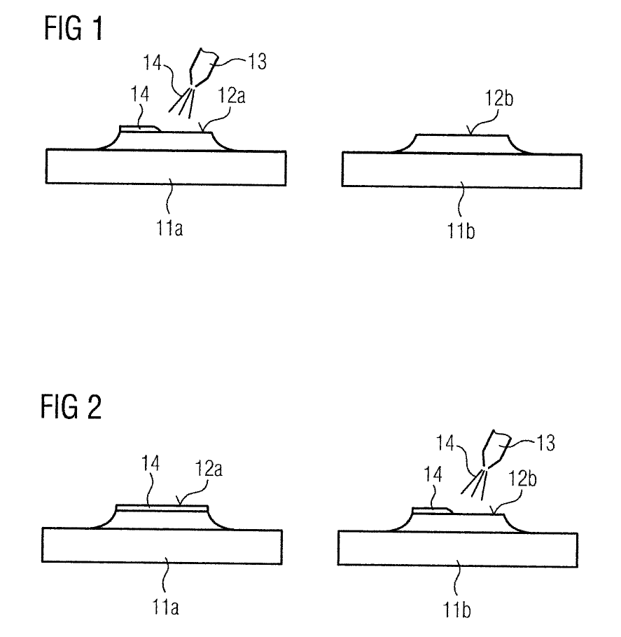

FIG. 1 illustrates a first step of the method according to an embodiment. Two components 11a, 11b with associated joining surfaces 12a, 12b can be seen, it being intended that the components 11a, 11b are connected to one another by means of the joining surfaces 12a, 12b. For this purpose, a joining adjuvant 14 is applied with a nozzle 13 to the joining surface 12a of the component 11a. This forms a layer on the joining surface 12a.

FIG. 2 illustrates an optional method step in which, in addition to the component 11a, the component 11b is also coated with the joining adjuvant 14, on the joining surface 12b. The nozzle 13 is likewise used here. The joining adjuvant 14 on the joining surface 12b may have the same composition as the joining adjuvant 14 on the joining surface 12a. Alternatively, it is also possible to vary the composition of the joining adjuvants 14 on the joining surfaces 12a and 12b. If, for example, the component 11a consists of aluminum, particles of pure aluminum could be added to the joining adjuvant 14 on the joining surface 12a. Furthermore, with the aid of aluminum carboxylate, an oxidic aluminum ceramic could be created, elementary aluminum particles being allowed to create a transition to the component 11a in the peripheral region with respect to the joining surface 12a.

The component 11b with its layer of joining adjuvant 14 could be of an identical structure to the component 11a. The component 11b could, however, also consist of a different metal, for example iron, with iron instead of aluminum being introduced as metallic particles into the joining adjuvant 14.

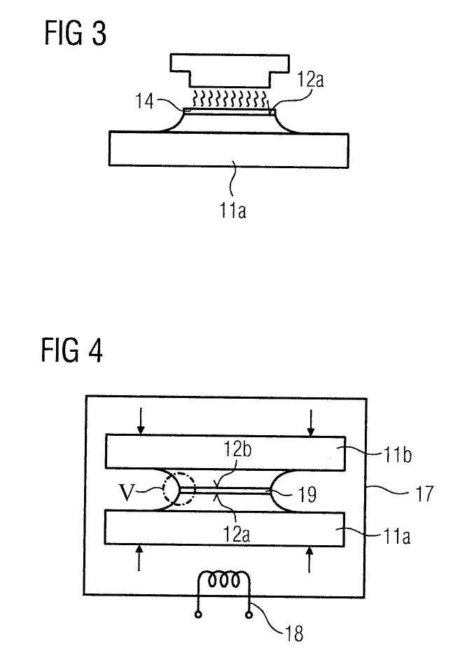

The step according to FIG. 3 is likewise optional. The applied layer of joining adjuvant 14 on the joining surface 12a is heated by means of a radiant heater 15, the joining adjuvant 14 being brought in this way to a defined temperature. This achieves evaporation of the solvent in the joining adjuvant 14, which is reduced to a prescribed concentration in the joining adjuvant. Heat treatment is ended when the required concentration of solvent in the joining adjuvant 14 is reached. In the same way as the component 11a, the component 11b may also be subjected to a heat treatment, in a way corresponding to FIG. 3, to evaporate solvent if it has likewise been provided with a joining adjuvant according to FIG. 2.

FIG. 4 shows the concluding heat treatment, which may optionally follow on respectively after the method step according to FIG. 1, according to FIG. 2 or according to FIG. 3. To produce the bonded connection, the components 11a, 11b are placed with their joining surfaces 12a, 12b one on top of the other and pressed one onto the other by means of a pressing force 16. The composite bond 11a, 11b preassembled in this way is placed in an oven 17, the interior of which is brought to a defined temperature by a heat source 18. After a treatment time dependent on the properties of the joining adjuvant 14 (cf. FIGS. 1 to 3), the heat treatment is interrupted. By a chemical transformation, the joining adjuvant has become a ceramic, forming an intermediate layer 19, which on the basis of its respective bonding to the joining surfaces 12a, 12b brings about a strong connection of the components 11a, 11b.

Without restricting generality, the following compound was created as a specific exemplary embodiment. A joining adjuvant was produced from 58% by weight zirconium(IV)2-ethylhexanoate, 3% by weight Y(III)2-ethylhexanoate and 39% by weight acetic acid as the solvent. The joining surfaces were subsequently cleaned with ethanol. The components to be joined consisted of aluminum, the joining adjuvant having been applied to both joining surfaces. Subsequently, the components were joined together at the joining surfaces and heated in an atmosphere of 400° C. for five minutes. The composite bond created subsequently cooled down to room temperature.

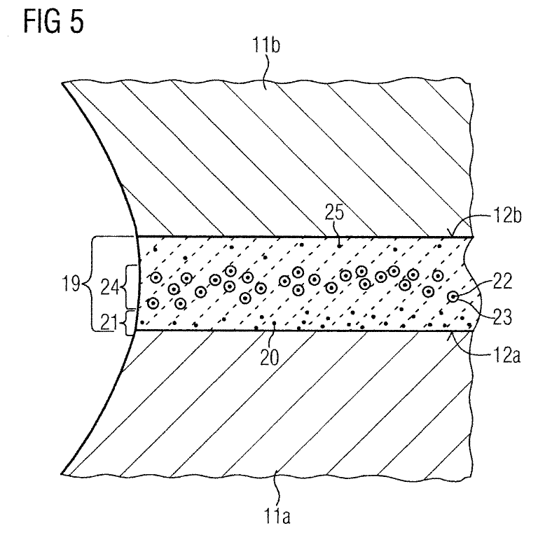

FIG. 5 illustrates the detail V according to FIG. 4 as a section. The material of the components 11a, 11b and the intermediate layer 19 connecting them can be seen. Furthermore, it can be seen that particles, which may perform different functions, have been introduced into the ceramic matrix of the layer 19. For example, microparticles 20 of aluminum, which create a transitional zone 21 between the component 11a of aluminum and the intermediate layer 19, are embedded on the joining surface 12a of the component 11a. Furthermore, in the region in which the two layers of joining adjuvant that have been respectively applied to the joining surfaces 12a, 12b meet, nanoparticles respectively comprising a core 22 and a shell 23 are provided. The core could be, for example, a dye which is enclosed by the shell. In the event of failure of the composite bond 11a, 11b on account of inadequate connection of the two layers of joining adjuvant on the joining surfaces 12a, 12b, the shells 23 would break open along the rupture line and release the dye. Failure of the intermediate layer 19 in a transitional zone 24 between the former partial layers (no longer visible in FIG. 5) of the joining adjuvant could consequently be easily ascertained and used as information to optimize the component connections. For example, the pressure with which the joining surfaces 12a, 12b are pressed could be increased as a consequence.

Furthermore, nanoparticles 25 may be distributed in a finely dispersed manner in the matrix of the layer 19. These may, for example, consist of a material which, as a diffusion reservoir, counteracts any change in the concentration in the relevant material in the layer on account of diffusion processes through the joining surface 12b into the component 11b.

As an example of the material bonding, a connection of two aluminum bodies was produced as follows:
1st step: production of the precursor comprising 58% by weight zirconium(IV)2-ethylhexanoate, 3% by weight yttrium(III)2-ethylhexanoate and acetic acid to make up 100% by weight
2nd step: cleaning of the surfaces of the aluminum bodies with ethanol
3rd step: application of the precursor to the cleaned aluminum surfaces, which are intended to be used as joining surfaces
4th step: joining together of the joining surfaces coated with the precursor
5th step: heating at 400° C. for 5 minutes
6th step: cooling down to room temperature

1. A method for the material bonding of two metallic components comprising the steps of:
using a joining adjuvant, which is applied to the joining surface of at least one of the components before the components are joined,
using precursors for a ceramic as the joining adjuvant and, after joining,
subjecting the components to a heat treatment until the precursors have been chemically transformed into a metal compound forming the ceramic, thereby forming an intermediate layer connecting the components.

2. The method according to claim 1, wherein the ceramic to be formed comprises at least one of an oxide, a nitride, and an oxinitride.

3. The method according to claim 1, wherein at least one metal in the metal compound to be formed of the ceramic is also contained in at least one of the components.

4. The method according to claim 2, wherein a metal carboxylate or a mixture of different metal carboxylates is used as precursors for the ceramic.

5. The method according to claim 4, wherein the precursors for the ceramic are dissolved in a solvent which contains a carboxylic acid.

6. The method according to claim 2, wherein a hydrazine compound is used as precursors for the ceramic.

7. The method according to claim 6, wherein the precursors for the ceramic are dissolved in a solvent which contains at least one of water and at least one alcohol.

8. The method according to claim 5, wherein before joining the components, a time is allowed, until a prescribed part of the solvent has evaporated.

9. The method according to claim 8, wherein the evaporation of the solvent is assisted by heating the components coated with the joining adjuvant.

10. The method according to claim 1, wherein at least one additive is added in the form of particles to the joining adjuvant.

11. The method according to claim 10, wherein nanoparticles are added as particles.

12. The method according to claim 1, wherein the components are pressed together at the joining surfaces during the transformation of the precursors into the ceramic.

13. The method according to claim 1, wherein the joining adjuvant or joining adjuvants of respectively different composition is/are applied to the joining surfaces of both components.

14. The method according to claim 5, wherein the solvent which contains a carboxylic acid is selected from the group consisting of 2-ethylhexanoic acid, acetic acid, propionic acid, hexanoic acid, levulinic acid, and mixtures of carboxylic acids.

15. The method according to claim 6, wherein the acids that are used comprise alkyl, alkenyl or alkynyl groups on the carbon chain.

16. The method according to claim 2, wherein hydrazine, monomethyl hydrazine or dimethyl hydrazine, or a mixture of different hydrazine compounds is used as precursors for the ceramic.

17. The method according to claim 16, wherein the precursors for the ceramic are dissolved in a solvent which contains at least one of water and ethanol.

18. The method according to claim 10, wherein the at least one additive is a metal a ceramic substance, or a dye.

19. The method according to claim 18, wherein the metal is selected from the group consisting of Y, Re, Th, Nb, Ta, V, Tc, Al, Cu, Cr, Fe, Co, Pt, Pd, Ag, Au, Ti, and Ni

20. The method according to claim 18, wherein the ceramic substance is selected from the group consisting of aluminum oxide, magnesium oxide, titanium oxide, hexagonal or cubic boron nitride, and silicon dioxide.
